(19) United States
(12) Patent Application Publication
(10) Pub. No.: US 2022/0222187 A1
(43) Pub. Date: Jul. 14, 2022

(54) CONTROLLER

(71) Applicant: Mitsubishi Electric Corporation, Tokyo (JP)

(72) Inventors: Naoki ITO, Tokyo (JP); Yohei TSUKAMOTO, Tokyo (JP)

(73) Assignee: Mitsubishi Electric Corporation, Tokyo (JP)

(21) Appl. No.: 17/712,577

(22) Filed: Apr. 4, 2022

Related U.S. Application Data
(63) Continuation of application No. PCT/JP2019/047960, filed on Dec. 6, 2019.

(51) Int. Cl. G06F 13/10; G06F 11/22; G06F 15/80

(52) U.S. Cl. CPC G06F 13/10; G06F 15/80; G06F 11/2221

(57) ABSTRACT

In a controller (10), a CPU device #1 has a first authority to manage a peripheral device #1, and is a management device for the peripheral device #1. Each of a CPU device #2 and a CPU device #3 is a general device that has a second authority, which is lower than the first authority, for the peripheral device #1. Upon failing to read data from the peripheral device #1, the general device executes a diagnosis on the peripheral device #1 based on the second authority. The diagnosis by the general device causes the CPU device #1, which is the management device for the peripheral device #1, to receive an error notification indicating the error in the peripheral device #1. Upon receiving the error notification, the CPU device #1, which is the management device, handles the error in the peripheral device #1 based on the first authority.

### CROSS-REFERENCE TO RELATED APPLICATIONS

This application is a Continuation of PCT International Application No. PCT/JP2019/047960, filed on Dec. 6, 2019, all of which is hereby expressly incorporated by reference into the present application.

### TECHNICAL FIELD

The present invention relates to a controller.

### BACKGROUND ART

In an embedded system used in a facility such as a factory or a power plant or in a transportation facility such as a train, control is realized by a controller. There are various ways to realize a controller. For example, a typical controller is composed of a combination of a central-processing-unit device (hereinafter, a CPU device) that periodically executes a stored control program and an input/output (I/O) device or a peripheral device having a communication device used for network connection, and the CPU device and the I/O device are connected through a bus, and the CPU device and the I/O device operate in coordination with each other.

A controller is, for example, a programmable logic controller (PLC).

As means for speeding up control by a controller in order to enhance the performance of a system, there is a multi-CPU configuration in which a plurality of CPU devices are provided in the controller. In the multi-CPU configuration, a control program to be executed by each CPU device is designed for each CPU device. Furthermore, a peripheral device to be used by each CPU device is provided for each CPU device. As a result, the control program of each CPU device is arranged to have low coupling and the speedup of the controller is realized. In the multi-CPU configuration, the CPU device that controls a certain peripheral device is called a management device. The CPU device itself becomes the management device for a plurality of peripheral devices. From the viewpoint of a peripheral device, only one CPU device is the management device.

In failure management in the controller with the multi-CPU configuration, the CPU device that is the management device for a peripheral device has an error handling method in case an error occurs in the peripheral device. Therefore, if an error occurs in the peripheral device, the management device detects the error and performs a diagnosis and necessary processing. The “diagnosis” is, for example, processing in which the management device reads an error code from the peripheral device in which the error has occurred and interprets the content of the error. The “necessary processing” is, for example, to stop all the functions or to stop some of the functions as the controller. Alternatively, the “necessary processing” is to continue control of other peripheral devices in which an error has not occurred and to perform recovery processing such as a reset for the peripheral device in which the error has occurred, without stopping the functions as the controller.

In recent years, parallelization techniques such as OpenMP are attracting attention. In the parallelization technique of OpenMP, one control program is automatically divided and executed in parallel. With this, OpenMP achieves a speedup of control by a controller. When the parallelization technique such as OpenMP is applied to a controller with the conventional multi-CPU configuration, it is assumed that the control program to be executed by each CPU device has high coupling. The reason for this is that the original control program that is divided is designed to be executed by one CPU device. In the control program with high coupling, processing such as the following is assumed. Input information that is input to a certain peripheral device is read by a plurality of CPU devices, regardless of whether or not each CPU device is the management device, and the read input information causes the plurality of CPU devices to simultaneously perform parallel execution.

Even in the case of simultaneous parallel execution by the plurality of CPU devices, it is typically arranged that a write to a peripheral device is performed only by one of the CPU devices, that is, only by the management device. The reason for this is as follows. If the plurality of CPU devices can write to the peripheral device, a command written by one of the CPU devices may be overwritten by another one of the CPU devices without being executed, depending on the write timing.

In failure management in an environment where the control program that is divided from a control program and has high coupling is executed in parallel in the controller with the multi-CPU configuration, the following is required. If an error occurs in a peripheral device, after detecting the error the management device needs to diagnose the peripheral device, decide necessary handling, and then notify the other CPU devices of a result of decision. In such a case, the CPU devices other than the management device do not have the error handling method. Therefore, even if the CPU devices other than the management device fail in a read due to the error in the peripheral device, the CPU devices continue control using, for example, information of the immediately preceding cycle and wait for a notification from the management device. Therefore, a problem is that if an error occurs in the peripheral device immediately after the management device has succeeded in a read from the peripheral device, the management device will detect the error by a failure in a read in the next cycle, so that it takes time to detect the error in the peripheral device.

As an existing technique related to the problem of a long time period from occurrence of an error in a peripheral device to detection of the error, there is Patent Literature 1.

In Patent Literature 1, CPU devices are arranged in a dual system of a main station and a slave station, and means for communicating with one another including a peripheral device to be managed is provided.

In Patent Literature 1, if a communication failure such as a read failure occurs between the main station and the peripheral device, the slave station takes over to attempt a read from the peripheral device and determine an error situation in the peripheral device. It is described that the detection of an error and the identification of the content of the error are performed promptly by processing by the slave station.

However, even when the technique of Patent Literature 1 is applied to the case where the control program with high coupling is executed in parallel in the multi-CPU configuration, if an error occurs immediately after the main station has succeeded in a read, the main station will fail in a read in the next cycle, and then the slave station will further attempt a read and determine an error situation. Therefore, Patent Literature 1 does not provide a solution to the problem that after an error occurs in a peripheral device, it takes time to detect the error.

### CITATION LIST

### Patent Literature

Patent Literature 1: JP H09-093308 A

### SUMMARY OF INVENTION

### Technical Problem

An object of the present invention is to shorten a time period from occurrence of an error in a peripheral device to detection of the error in the peripheral device by a CPU device that is a management device in a controller with a multi-CPU configuration, when a plurality of CPU devices execute, in parallel, a control program that is divided using a parallelization technique and has relatively high coupling.

### Solution to Problem

A controller according to the present invention includes

a plurality of central-processing-unit devices; and

a peripheral device from which data is read by the plurality of central-processing-unit devices,

wherein the plurality of central-processing-unit devices include

a management device and a general device, the management device being a central-processing-unit device that has a first authority to manage the peripheral device, the general device being a central-processing-unit device that has a second authority, which is lower than the first authority, to diagnose an error in the peripheral device in which the error has occurred,

wherein the general device includes

a read unit to read data from the peripheral device; and

a diagnosis unit to execute a diagnosis on the peripheral device based on the second authority when a data read from the peripheral device has failed, and

wherein the management device includes

a communication unit to receive an error notification indicating the error in the peripheral device, the communication unit being caused to receive the error notification by the diagnosis; and

a handling unit to handle the error in the peripheral device based on the first authority when the error notification is received.

### Advantageous Effects of Invention

In the present invention, a diagnosis by a general device causes a management device to receive an error notification indicating an error in a peripheral device. Therefore, according to the present invention, it is possible to shorten a time period from occurrence of an error in a peripheral device to detection of the error in the peripheral device by a CPU device that is a management device, when a plurality of CPU devices execute in parallel a control program that is divided using a parallelization technique and has relatively high coupling.

### BRIEF DESCRIPTION OF DRAWINGS

FIG. 1 is a diagram of a first embodiment and illustrates a hardware configuration of a controller;

FIG. 2 is a diagram of the first embodiment and illustrates a hardware configuration of a CPU device;

FIG. 3 is a diagram of the first embodiment and illustrates a hardware configuration of an I/O device;

FIG. 4 is a diagram of the first embodiment and illustrates error detection information;

FIG. 5 is a diagram of the first embodiment and a flowchart illustrating operation of an error detection unit;

FIG. 6 is a diagram of the first embodiment and illustrates operation of the controller;

FIG. 7 is a diagram of a second embodiment and illustrates a hardware configuration of an I/O device;

FIG. 8 is a diagram of the second embodiment and illustrates operation of a controller;

FIG. 9 is a diagram of a third embodiment and illustrates operation of a controller;

FIG. 10 is a diagram of a fourth embodiment and illustrates a hardware configuration of a controller;

FIG. 11 is a diagram of the fourth embodiment and illustrates a hardware configuration of an authority device;

FIG. 12 is a diagram of the fourth embodiment and illustrates state transitions of a granting unit 311;

FIG. 13 is a diagram of the fourth embodiment and a flowchart illustrating operation of an error detection unit;

FIG. 14 is a diagram of the fourth embodiment and illustrates operation of the controller; and

FIG. 15 is a diagram of the fourth embodiment and is a supplement to the hardware configuration of a CPU device 100.

### DESCRIPTION OF EMBODIMENTS

Embodiments for implementing the present invention will be described hereinafter with reference to the drawings. The terms to be used in the following embodiments will now be described. In the following embodiments, a plurality of CPU devices will be presented. The plurality of CPU devices in the following description include a management device and a general device.

(1) The management device is a CPU device that has a first authority to manage a peripheral device.

(2) The general device is a CPU device that has a second authority, which is lower than the first authority, to diagnose an error in a peripheral device in which the error has occurred.

For example, the first authority is the authority permitted to write to the peripheral device. The second authority is the authority not permitted to write to the peripheral device, and permitted to read an error code from the peripheral device.

### First Embodiment

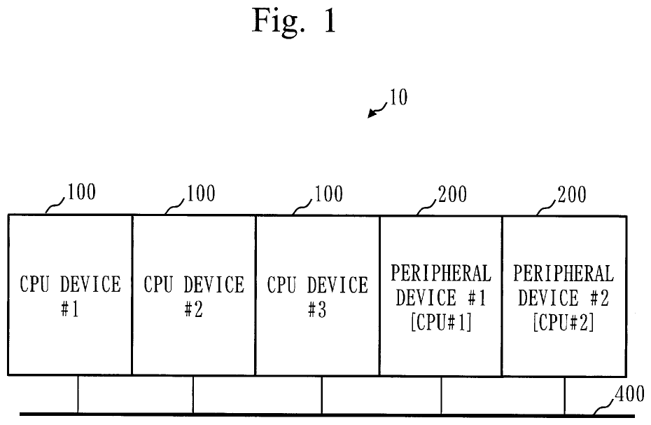

Referring to FIGS. 1 to 6, a controller 10 of a first embodiment will be described. In the controller of the first embodiment, while each CPU device is executing in parallel a control program 121 divided from an original control program, a CPU device 100 that has detected an error in a peripheral device notifies other CPU devices 100 of the error. This allows the management device to promptly know the occurrence of the error in the peripheral device. Referring to the drawings, the controller 10 will be described below.

***Description of Configurations***

FIG. 1 illustrates a hardware configuration of the controller 10 of the first embodiment. The controller 10 includes CPU devices 100 and peripheral devices 200 from which data is to be read by the CPU devices 100. In the controller 10, the CPU devices 100 each storing a control program to be described later and the peripheral devices are connected through a bus 400. Each of the CPU devices is the device that periodically executes the stored control program. Each of the peripheral devices is the device that inputs and outputs data by communicating with a device different from the CPU devices. In FIG. 1, three CPU devices 100 are identified by #1, #2, and #3, which are identifiers. In the following, the CPU devices 100 may be represented as the CPU device #1 and so on. In FIG. 1, two peripheral devices 200 are identified by #1 and #2, which are identifiers.

In the following, the peripheral devices 200 may be represented as the peripheral device #1 and so on. The peripheral devices 200 are assumed to be I/O devices 200. In the description after FIG. 1, the I/O devices may be represented as the I/O devices 200.

In FIG. 1, CPU #1 is written under the peripheral device #1, and CPU #2 is written under the peripheral device #2. This indicates that the management device for the peripheral device #1 is the CPU device #1, and the management device for the peripheral device #2 is the CPU device #2. The correspondence between a peripheral device and a management device is defined by error processing information 122 to be described later.

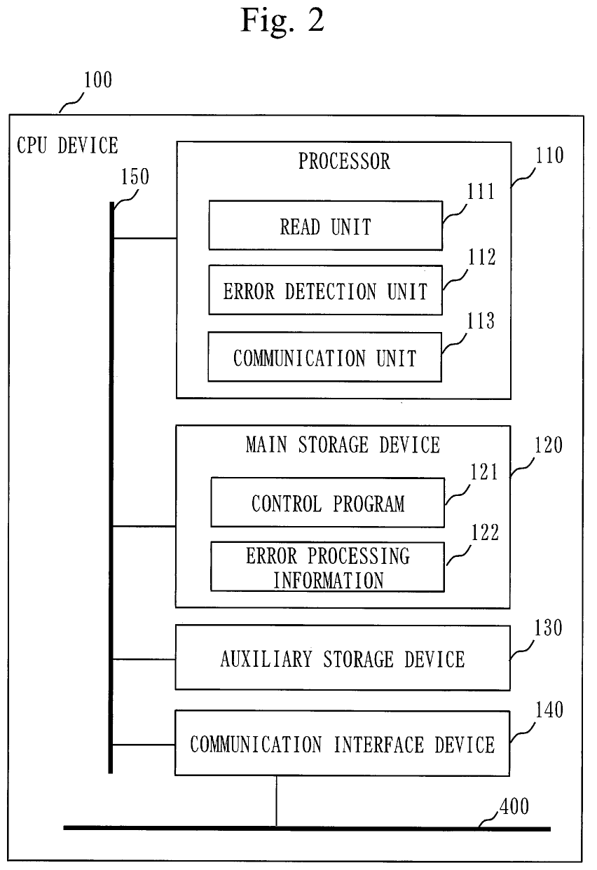

FIG. 2 illustrates a hardware configuration of the CPU device 100. The CPU device 100 includes, as hardware, a processor 110, a main storage device 120, an auxiliary storage device 130, and a communication interface device 140. The processor 110 is connected with the main storage device 120, the auxiliary storage device 130, and the communication interface device 140 through a bus 150.

The main storage device 120 stores the control program 121 to be executed by the processor 110 and the error processing information 122.

The auxiliary storage device 130 stores, in a non-volatile manner, information and data to be stored in the main storage device 120. The processor 110 loads the control program 121 and the error processing information 122 from the auxiliary storage device 130 into the main storage device 120, and reads the loaded control program 121 and error processing information 122 from the main storage device 120 for execution.

The communication interface device 140 is used for communication between two hardware components among the processor 110, the main storage device 120, and the auxiliary storage device 130, communication between the CPU devices 100, or communication between the CPU device 100 and the peripheral device 200.

The CPU device 100 includes, as functional elements, a read unit 111, an error detection unit 112, and a communication unit 113. The functions of the read unit 111, the error detection unit 112, and the communication unit 113 are realized by the control program 121. The read unit 111 reads data from the peripheral device 200. When the CPU device 100 is the general device, the error detection unit 112 is a diagnosis unit. When a data read from the peripheral device 200 has failed, the error detection unit 112 that is the diagnosis unit executes a diagnosis on the peripheral device 200 based on the second authority.

The processor 110 is a device that executes the control program 121. The processor 110 is an integrated circuit (IC) that performs operational processing. Specific examples of the processor 110 are a central processing unit (CPU), a digital signal processor (DSP), and a graphics processing unit (GPU).

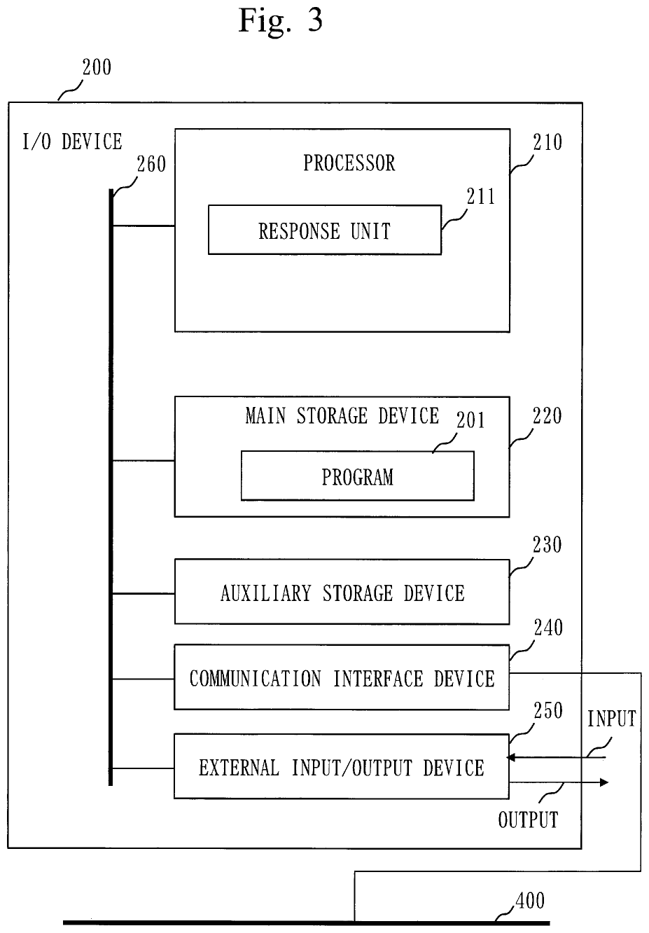

FIG. 3 illustrates a hardware configuration of the I/O device 200. The I/O device includes, as hardware, a processor 210, a main storage device 220, an auxiliary storage device 230, a communication interface device 240, and an external input/output device 250. The processor 210 is connected with the main storage device 220, the auxiliary storage device 230, the communication interface device 240, and the external input/output device 250 through a bus 260.

The processor 210 performs processing such as simple operations depending on the state of the external input/output device 250 and generation of an error code based on a result of a self-diagnosis. In the main storage device 220 and the auxiliary storage device 230, results of self-diagnoses performed by the processor 210 and error codes are stored. The communication interface device 240 is used for communication between two hardware components among the processor 210, the main storage device 220, the auxiliary storage device 230, and the external input/output device 250 and communication between the peripheral device 200 and the CPU device 100. The external input/output device 250 fetches data from an external device different from the CPU device 100, and outputs data to the external device.

The I/O device 200 includes a response unit 211 as a functional element. When there is a data read request from the CPU device 100, the response unit 211 cooperates with the external input/output device 250 to transmit the requested data to the CPU device 100 via the communication interface device 240. The functions of the response unit 211 are realized by a program 201. The program 201 is stored in the auxiliary storage device 230. The processor 210 loads the program 201 from the auxiliary storage device 230 into the main storage device 220, and reads the program 201 from the main storage device 220.

The processor 210 is a device that executes the program 201. Specific examples of the processor 210 are substantially the same as those of the processor 110.

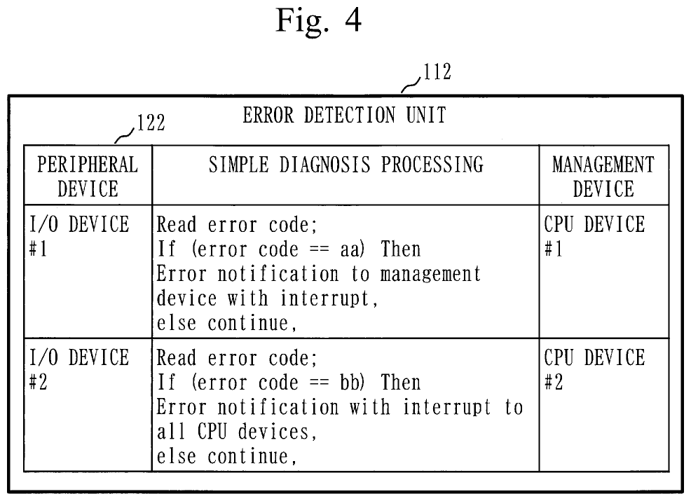

FIG. 4 illustrates the error processing information 122. The error processing information 122 is stored in the auxiliary storage device 130. The processor 110 loads the error processing information 122 from the auxiliary storage device 130 into the main storage device 120, and refers to the error processing information 122 in the main storage device 120. The error processing information 122 is pre-defined by an administrator, depending on the system configuration of the controller 10. The defined error processing information 122 is stored in the auxiliary storage device 130. In the error processing information 122 of FIG. 4, each peripheral device included in the controller 10 is defined in the left column. The content of simple diagnosis processing is defined in the center column. The “content of simple diagnosis processing” is the content of processing to be performed, upon occurrence of an error in the peripheral device, by the CPU device 100 that has detected the error. The CPU device 100 to be the management device for the peripheral device is defined in the right column.

A record of the I/O device #1 will be described. This record will be referred to as a first record. In the first record, the management device for the I/O device #1 is the CPU device #1. The following (1) to (3) indicate the content of the simple diagnosis processing in the first record.

(1) Read an error code.

(2) If the content of the error code is aa, the CPU device 100 transmits an error notification with an interrupt to the CPU device #1, which is the management device. The error code “aa” denotes a specific error code.

(3) If the error code that has been read is other than “aa”, the CPU device 100 continues processing without transmitting an error notification to the CPU device #1, which is the management device.

A record of the I/O device #2 will be described. This record will be referred to as a second record. In the second record, the management device for the I/O device #2 is the CPU device #2. The following (1) to (3) indicate the content of simple diagnosis processing in the second record.

(1) Read an error code.

(2) If the content of the error code is bb, the CPU device 100 transmits an error notification with an interrupt to all the CPU devices 100. Note that “bb” denotes a specific error code different from “aa”.

(3) If the error code that has been read is other than “bb”, the CPU device 100 continues processing without transmitting an error notification.

***Description of Operation***

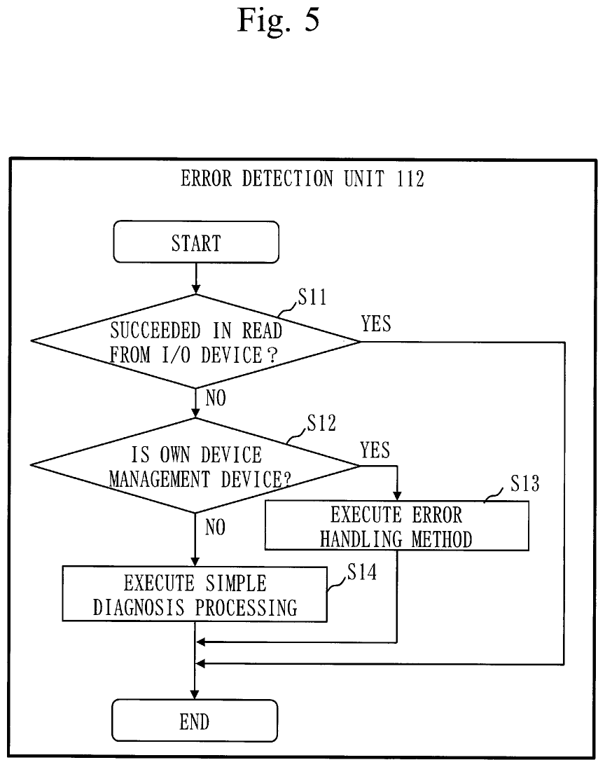

FIG. 5 is a flowchart illustrating operation of the error detection unit 112.

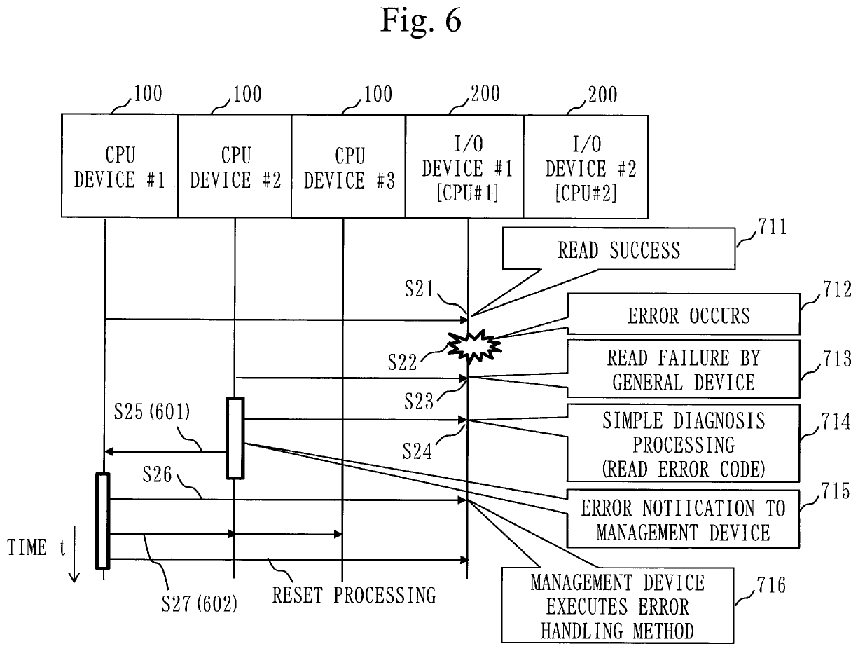

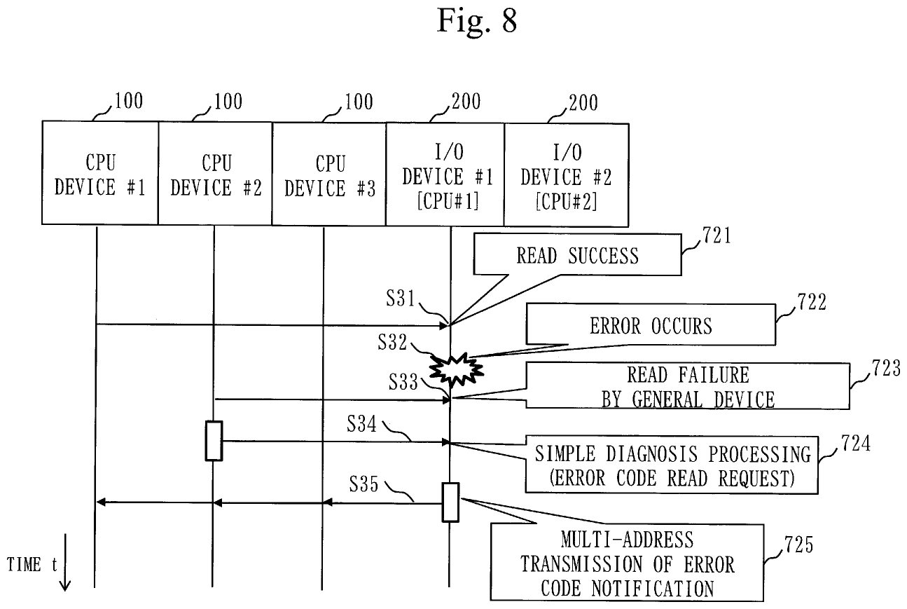

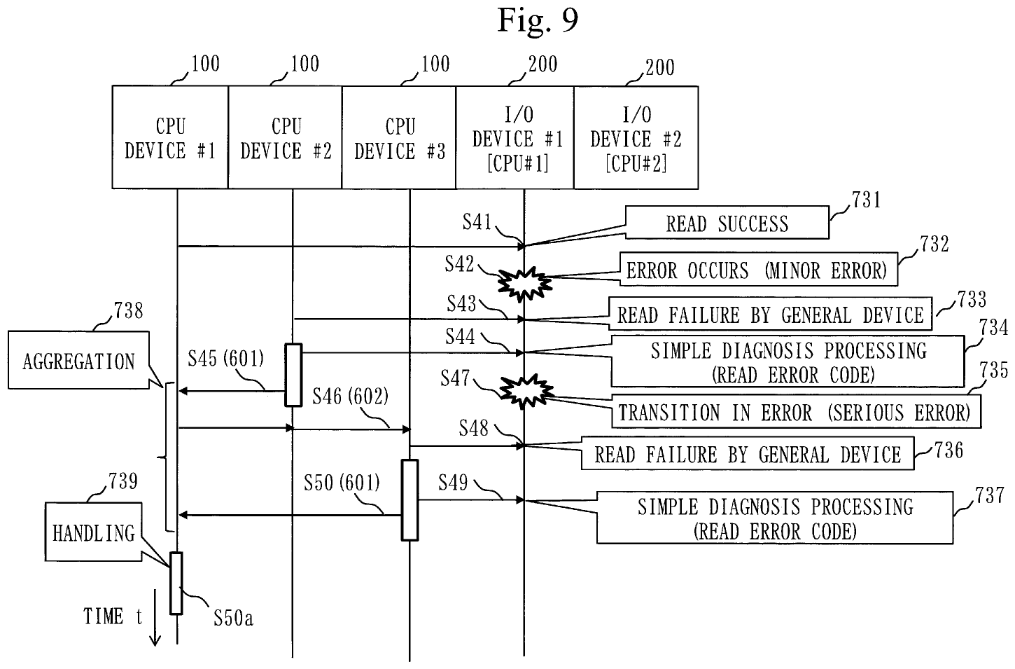

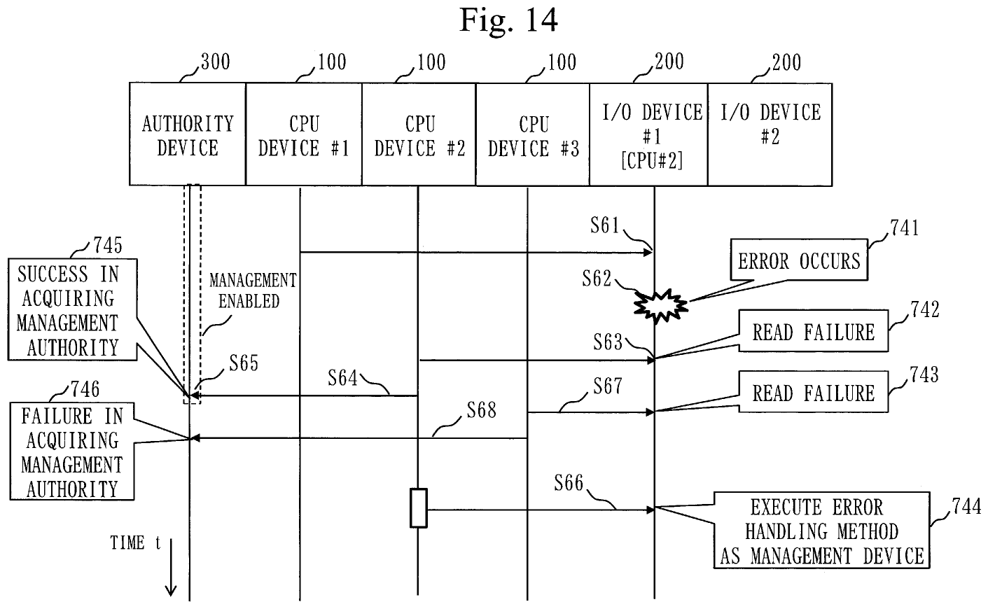

FIG. 6 illustrates operation of the controller 10 of the first embodiment. Events indicated in boxes 711, 712, 713, 714, 715, and 716 in FIG. 6 indicate non-periodic processing. Events indicated in boxes 721, 722, 723, 724, and 725 in FIG. 8, events indicated in boxes 731, 732, 733, 734, 735, 736, 737, 738, and 739 in FIG. 9, and events indicated in boxes 741, 742, 743, 744, 745, and 746 in FIG. 14, which are to be described later, also indicate non-periodic processing.

Referring to FIGS. 5 and 6, the operation of the controller 10 will be described. In the following description, the operation of the controller 10 will be described, assuming that an error has occurred in the I/O device #1 in FIG. 1.

FIG. 5 will be described. The read unit 111 performs a data read from the I/O device #1.

In step S11, the error detection unit 112 determines whether the data read by the read unit 111 has succeeded. If it has succeeded, processing ends. If it has failed, processing proceeds to step S12.

In step S12, the error detection unit 112 refers to the error processing information 122 to determine whether its own CPU device is the management device for the I/O device #1. If it is the management device, processing proceeds to step S13. If it is not the management device, processing proceeds to step S14.

In step S13, the error detection unit 112 of the management device executes a pre-set error handling method.

In step S14, the error detection unit 112 of the general device refers to the “simple diagnosis processing” in the error processing information 122 and executes the simple diagnosis processing for the I/O device #1.

<Advance Setting>

A designer of the control program 121 to be stored in the CPU device 100 determines in advance the error handling method, mentioned in step S13, to be executed by the management device, taking into consideration the influence that an error in the I/O device has on a system in which the controller 10 is used. The designer of the control program 121 also defines the content of the error processing information 122 in advance and sets it in the auxiliary storage device 130 of each CPU device 100. After the system is put into operation, the error detection unit 112 of each CPU device 100 periodically executes the processing of FIG. 5. The content of the simple diagnosis processing in step S14 of FIG. 5 is the “simple diagnosis processing” of the error processing information 122 of FIG. 4. The simple diagnosis processing in step S14 is simple processing that is possible within the scope of the second authority permitted for the CPU device 100 that is the general device.

The simple diagnosis processing in step S14 is, for example, a read of an error code. The control program 121 that executes the simple diagnosis processing is not “designed for each CPU device on the assumption of the multi-CPU configuration”. The following is assumed for the control program 121. An original control program of the control program 121 is divided using a parallelization technique. The control program 121 is the program divided from this original control program. The control program 121 divided from the original control program is stored in each CPU device 100, and each CPU device 100 executes the control program 121 in parallel. In this way, the control program 121 is assumed to have relatively high coupling.

Referring to FIG. 6, the operation of the controller 10 will be described.

In step S21, the read unit 111 of the CPU device #1 succeeds in a read from the external input/output device 250 of the I/O device #1.

In step S22, immediately after the CPU device #1 has succeeded in the read, an error occurs in the I/O device #1. Before the occurrence of the error, the CPU device #1, the CPU device #2, and the CPU device #3 refer to input information input to the external input/output device 250 of the I/O device #1 in sequence. In this state, the CPU device #1, the CPU device #2, and the CPU device #3 are executing the respective control programs 121 in parallel.

In step S23, the read unit 111 of the CPU device #2 refers to the input information of the I/O device #1 after the occurrence of the error. Since the error has occurred in the I/O device #1, the read unit 111 of the CPU device #2 fails in a read. The error detection unit 112 of the CPU device #2 detects the failure in the read by the read unit 111. As indicated in the error processing information 122, the CPU device #2 is not the management device for the I/O device #1.

In step S24, the error detection unit 112 of the CPU device #2, which is the general device, reads an error code from the I/O device #1, which is the peripheral device 200, as execution of a diagnosis by the simple diagnosis processing, and upon reading the error code, transmits an error notification to the CPU device #1, which is the management device. Specifically, this is as described below. In the CPU device #2, upon detecting the failure in the read from the I/O device #1, the error detection unit 112, which is the diagnosis unit, executes the simple diagnosis processing for the I/O device #1 in accordance with the error processing information 122, as indicated in the flowchart of FIG. 5. In step S24, it is assumed that the error detection unit 112 acquires the error code “aa” from the I/O device #1.

In step S25, since the error code is “aa”, the error detection unit 112 of the CPU device #2 transmits an error notification 601 to notify the occurrence of the error to the CPU device #1, which is the management device for the I/O device #1. The diagnosis by the simple diagnosis processing by the CPU device #2, which is the general device, causes the communication unit 113 to receive the error notification 601 indicating the error in the I/O device #1, which is the peripheral device 200.

When the CPU device 100 is the management device, the error detection unit 112 is a handling unit. Upon receiving the error notification 601, the error detection unit 112 that is the handling unit handles the error in the peripheral device 200 based on the first authority. Specifically, this is as described below.

In step S26, the reception of the error notification 601 causes an interrupt to be generated in the CPU device #1, which is the management device, while the control program 121 is being executed, and the error detection unit 112 of the CPU device #1 executes the error handling method for the I/O device #1 with the highest priority. The error handling method by the management device varies with the specifications of the peripheral device or the content of the error. In FIG. 6, the CPU device #1, which is the management device, checks the content of the error code of the I/O device #1 and then decides the handling method.

In step S27, the error detection unit 112 of the CPU device #1, which is the management device, judges that the system should be stopped as the error handling method, and transmits a management notification 602, which is the notification to notify the error and involves an interrupt, to all the other CPU devices. By the management notification 602, the error detection unit 112 of the CPU device #1 causes all the other CPU devices to stop executing the control program 121. The error detection unit 112 of the CPU device #1 executes reset processing for the I/O device #1 in which the error has occurred so as to attempt recovery.

Depending on the content of the error code, the error notification 601 may involve an interrupt to the control program 121 or may be without an interrupt. The error detection unit 112 can decide whether or not an interrupt is to be involved, depending on the content of the error code.

The error notification 601 defined in the error processing information 122 of FIG. 4 may be transmitted by multi-address transmission to all the CPU devices, as defined in the second record, instead of being transmitted only to the management device. In a case of a serious error such as a failure to read an error code in the simple diagnosis processing by the error detection unit 112, this multi-address transmission may involve an interrupt to all the CPU devices to stop the execution of the control program 121.

### Effects of First Embodiment

In the controller 10, all the CPU devices 100 have the error processing information 122. In the error processing information 122, the simple diagnosis processing that can be executed within the scope of the second authority permitted for the general device is defined. By the simple diagnosis processing, the error notification 601 is transmitted to the management device.

Accordingly, the CPU device 100 that is the general device executes the simple diagnosis processing based on the error processing information 122, so that when an error occurs in a peripheral device the management device can know the error in the peripheral device without waiting for the next read cycle.

Therefore, when a plurality of CPU devices each execute a control program that is divided using a parallelization technique and has relatively high coupling, it is possible to shorten a time period from occurrence of an error in a peripheral device to detection of the error in the peripheral device by the CPU device that is the management device.

### Second Embodiment

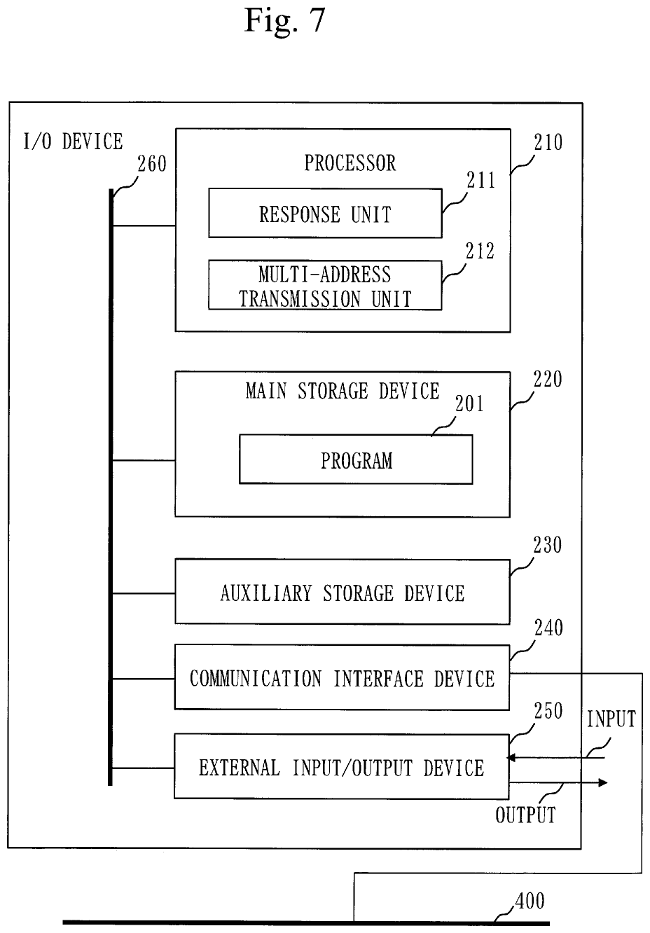

Referring to FIGS. 7 and 8, a second embodiment will be described.

FIG. 7 illustrates a configuration of an I/O device of the second embodiment.

FIG. 8 illustrates operation of the controller 10 of the second embodiment. The I/O device 200 of FIG. 7 includes a multi-address transmission unit 212 as a functional element in comparison with the I/O device 200 of FIG. 3. The configuration of the CPU device 100 is the same as that of FIG. 2 of the first embodiment. The configuration of the controller 10 is the same as that of FIG. 1.

In the first embodiment, after reading the error code from the peripheral device 200, the CPU device 100 that is the general device needs to transmit the error notification 601 to the management device that has the error handling method, as indicated in the error processing information 122 of FIG. 4 and in step S14 of FIG. 5. In contrast to this, in the second embodiment the multi-address transmission unit 212 of the I/O device 200 transmits the error notification 601 to each CPU device 100.

***Description of Operation***

Referring to FIG. 8, the operation of the controller 10 will be described. Step S31 to step S34 of FIG. 8 are the same as step S21 to step S24 of FIG. 6. Note that the CPU device #1, the CPU device #2, and the CPU device #3 execute the processing of FIG. 5.

In the second embodiment, the multi-address transmission unit 212 of the I/O device 200 to which an error code read request has been made from a general device transmits a result of reading the error code not only to the general device that has made the error code read request but also to all the CPU devices 100 by multi-address transmission.

In step S31, the read unit 111 of the CPU device #1 succeeds in a read from the external input/output device 250 of the I/O device #1.

In step S32, an error occurs in the I/O device #1 immediately after the CPU device #1 has succeeded in the read.

In step S33, after the error has occurred, the read unit 111 of the CPU device #2, which is the general device, refers to input information in the I/O device #1 as a read from the I/O device #1.

In step S34, the error detection unit 112 of the CPU device #2 detects a failure in the read by the read unit 111 and executes the simple diagnosis processing in accordance with the definition in the error processing information 122. The error detection unit 112 of the CPU device #2 transmits an error code read request to the I/O device #1 in accordance with the error processing information 122.

In step S35, when a diagnosis is executed by the simple diagnosis processing by the general device, the multi-address transmission unit 212 of the I/O device #1, which is the peripheral device, transmits the error notification 601 to the CPU devices 100 by multi-address transmission. Upon receiving the error code read request, the multi-address transmission unit 212 of the I/O device #1 transmits a result of reading the error code, which is equivalent to the error notification 601, to all the CPU devices 100 by multi-address transmission via the communication interface device 240. At this time, the multi-address transmission unit 212 of the I/O device #1 may limit the CPU devices 100 to be included in the multi-address transmission, depending on its own error situation, or may directly transmit the error notification 601 to the CPU device #1, which is the management device. The error notification 601 may involve an interrupt.

### Effects of Second Embodiment

In the controller 10 of the second embodiment, the I/O device transmits a result of reading an error code as the error notification 601 to all the CPU devices by multi-address transmission. Therefore, in a situation where the I/O device is capable of response, the management device can receive the error notification from the I/O device without waiting for the error notification 601 from the general device, so that the error detection time of the management device can be further shortened in comparison with the first embodiment.

### Third Embodiment

Referring to FIG. 9, the controller 10 of a third embodiment will be described. The configuration of the controller 10 of the third embodiment is the same as that of the controller 10 of the first embodiment. In the third embodiment, the management device aggregates the contents of error notifications 601 transmitted by the general devices. The management device executes the error handling method for the I/O device in which an error has occurred, based on a result of aggregation.

There may be a case in which an initial minor error in the I/O device 200 becomes a serious error due to spreading of the error, resulting in a transition in the error situation. Even when a transition occurs in the error situation, the controller 10 of the third embodiment can promptly and appropriately cope with the transition in the error situation.

In the third embodiment, it is assumed that the definition of an error code in the error processing information 122 of FIG. 4 includes a plurality of error codes such as aa1, aa2, aa3, and aa4. Upon detecting an error in the I/O device 200, the error detection unit 112 of the CPU device 100 transmits the error notification 601 including an error code to the management device.

The error detection unit 112 of each CPU device 100 executes the simple diagnosis processing defined in the error processing information 122 when the error notification 601 is received from another CPU device 100 and also when the management notification 602 is received from the management device. As a result of the simple diagnosis processing, the error detection unit 112 of each CPU device 100 transmits the error notification 601 including an error code to the management device. The management device receives the error notifications 601 from all the CPU devices 100. For example, the management device may handle the error based on the most serious error code among the error notifications 601, or may handle the error in the I/O device 200 based on the error code included in the latest error notification 601. In this way, the management device aggregates the contents of the error codes included in the received error notifications 601.

In this case, the error detection unit 112 of the management device may handle the error when it becomes possible to handle the error, without waiting until the error notifications 601 are received from all the CPU devices 100.

***Description of Operation***

FIG. 9 illustrates operation of the controller 10 of the third embodiment. Referring to FIG. 9, the operation of the controller 10 will be described. Step S41 to step S44 of FIG. 9 are the same as step S21 to step S24 of FIG. 6. The CPU device #1, the CPU device #2, and the CPU device #3 execute the processing of FIG. 5.

In step S41, the read unit 111 of the CPU device #1 succeeds in a read from the external input/output device 250 of the I/O device #1.

In step S42, an error occurs in the I/O device #1 immediately after the CPU device #1 has succeeded in the read.

In step S43, after the error has occurred in the I/O device #1, the read unit 111 of the CPU device #2, which is the general device, refers to input information in the I/O device #1 for a data read.

In step S44, the error detection unit 112 of the CPU device #2 detects a failure in the read by the read unit 111, and executes the simple diagnosis processing for the I/O device #1 based on the error processing information 122.

In step S45, the error detection unit 112 of the CPU device #2 transmits the error notification 601 including an error code to the CPU device #1, which is the management device.

In step S46, the error detection unit 112 of the CPU device #1 transmits the management notification 602 to the CPU device #2 and the CPU device #3.

In step S47, the error in the I/O device #1 makes a transition to a serious error.

In step S48, the read unit 111 of the CPU device #3 performs a data read from the I/O device #1. Since the error has occurred in the I/O device #1, the read unit 111 fails in the read.

In step S49, the error detection unit 112 of the CPU device #3 detects the failure in the data read by the read unit 111, and executes the simple diagnosis processing for the I/O device #1 in accordance with the error processing information 122.

In step S50, the error detection unit 112 of the CPU device #3 transmits the error notification 601 including an error code to the CPU device #1, which is the management device.

In step S50a, the error detection unit 112 of the CPU device #1, which is the management device, receives the error notifications 601 from the general devices, and handles the error in the peripheral device 200 based on the received error notifications 601. Specifically, the error detection unit 112 of the CPU device #1 aggregates the contents of the error codes in the error notifications 601 received from the CPU device #2 and the CPU device #3, and decides the error handling method for the I/O device #1 based on a result of aggregation.

### Effects of Third Embodiment

In the third embodiment, each general device executes the simple diagnosis processing regardless of whether the error notification 601 is received from another general device or the management notification 602 is received from the management device, and notifies the management device of a result of the simple diagnosis processing. The management device decides the error handling method for the peripheral device in which an error has occurred, based on error notifications, which are results of the simple diagnosis processing, received from all the general devices. Therefore, the management device can promptly and flexibly cope with an error situation in the peripheral device that changes over time. That is, the management device can cope with a serious error that occurs over time or the latest error in the peripheral device.

### Fourth Embodiment

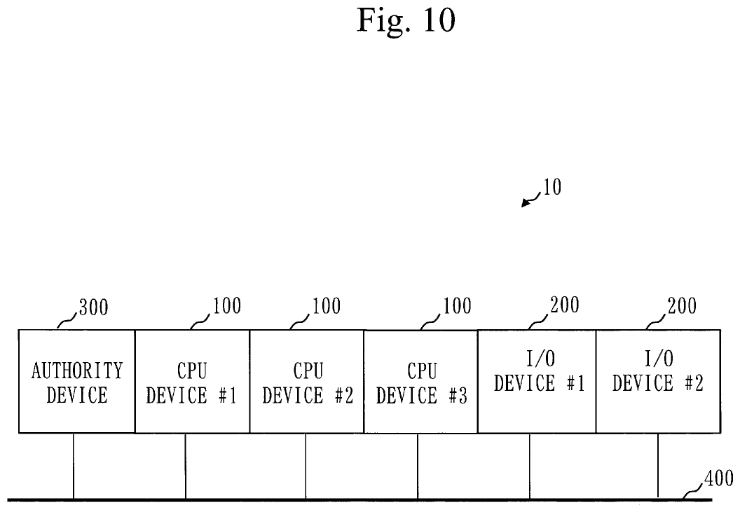

Referring to FIGS. 10 to 14, a fourth embodiment will be described. In the first to third embodiments, error handling for the I/O device 200 such as recovery processing or save processing after occurrence of an error in the I/O device 200 can be executed only by the management device that has the authority to write to the I/O device 200. For this reason, depending on the execution status of the control program 121 in the management device, a delay may occur in the start of error handling for the I/O device 200. Since the management device handles an error after receiving the error notification 601, this may also delay the start of error handling.

As a countermeasure against a delay in the start of error handling, if it is simply arranged that all the CPU devices have the error handling methods for all the I/O devices 200 so that all the CPU devices 100 can execute the error handling methods for all the I/O devices 200, the following situation arises.

An example using the CPU device #1, the CPU device #2, and the I/O device #1 will be described. Each of the CPU device #1 and the CPU device #2 is assumed to be equivalent to the management device for the I/O device #1. While the CPU device #1 is executing recovery processing for the I/O device #1, the CPU device #2 fails in a read from the I/O device #1. Then, the CPU device #2 starts recovery processing for the I/O device #1, so that the recovery processing by the CPU device #1 and the recovery processing by the CPU device #2 occur, resulting in redundant processing.

An object of the fourth embodiment is to promptly start error handling for the I/O device 200 and eliminate the redundancy of recovery processing.

FIG. 10 is a hardware configuration of the controller 10 of the fourth embodiment. The controller 10 of the fourth embodiment further includes an authority device 300 in comparison with the controller 10 of the first embodiment. The authority device 300 is connected to the bus 400. In the controller 10 of FIG. 10, all the CPU devices 100 have the error handling method for each I/O device 200. The management device for each I/O device 200 is not particularly specified. As will be described later, all the CPU devices 100 can be the management device. In the CPU device 100 of the fourth embodiment, the error detection unit 112 has the functions of both the diagnosis unit and the handling unit.

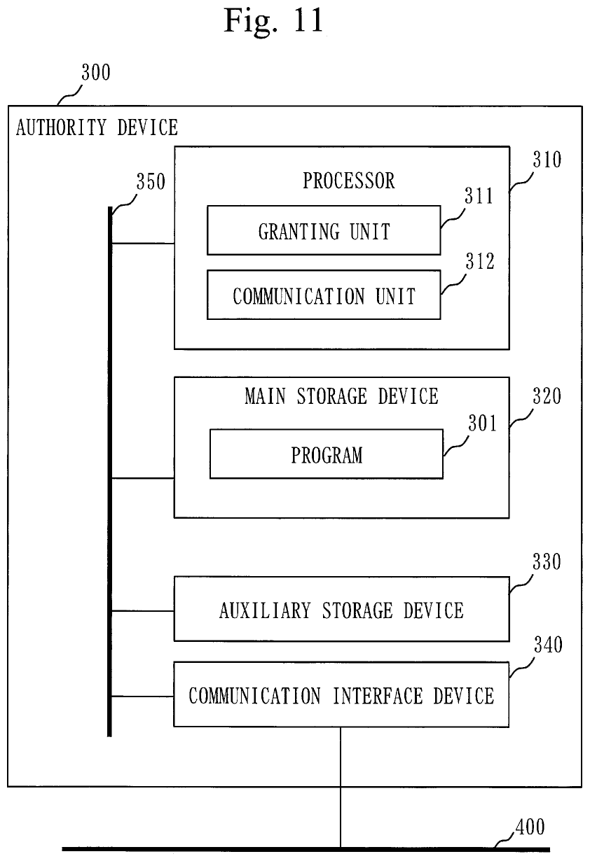

FIG. 11 illustrates a hardware configuration of the authority device 300. The hardware configuration of the authority device 300 is substantially the same as that of the CPU device 100 of FIG. 2. The authority device 300 includes, as hardware, a processor 310, a main storage device 320, an auxiliary storage device 330, and a communication interface device 340. The processor 310 is connected with the main storage device 320, the auxiliary storage device 330, and the communication interface device 340 through a bus 350. The authority device 300 includes, as functional elements, a granting unit 311 and a communication unit 312 to control communication between the authority device 300 and the CPU device 100. The processor 310 reads a program 301 from the main storage device 320, and executes it. The program 301 is the program that realizes the granting unit 311 and the communication unit 312. The program 301 is stored in the auxiliary storage device 330. The communication unit 312 receives request information requesting the granting of the authority to manage the peripheral device 200 from the CPU device 100 that has failed to read data from the peripheral device 200 from which data is to be read by the read unit 111 of each CPU device 100. Upon receiving the request information, the granting unit 311 grants the authority to the CPU device 100 that has requested the granting of the authority only when the authority has not been granted to another CPU device 100, and based on the authority, permits the handling of the peripheral device 200 by the error detection unit 112, which is the handling unit.

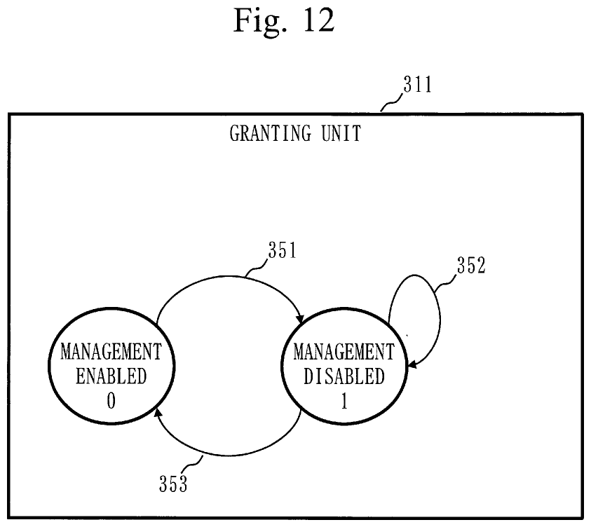

FIG. 12 is a state transition diagram of the granting unit 311 that grants the CPU device 100 the authority for diagnosis processing for the I/O device 200 in which an error has been detected. The initial state of the granting unit 311 is a “management enabled state”. This authority corresponds to the first authority of the management device. The “management enabled state” means the state in which the authority for diagnosis processing for the I/O device 200 can be granted to the CPU device 100. When a request for management of the I/O device 200 is received from one of the CPU devices 100 in the management enabled state, the granting unit 311 responds to the CPU device 100 with a management permission, and makes a transition to a “management disabled state”. This is a transition 351. The “management disabled state” means the state in which the authority for diagnosis processing for the I/O device 200 cannot be granted to the CPU device 100. When a management request is received from one of the CPU devices 100 in the “management disabled state”, the granting unit 311 responds to the CPU device 100 with a non-permission. This is a transition 352. When a notification to return the management authority is received from the CPU device 100, the granting unit 311 makes a transition to the management enabled state. This is a transition 353. The state transition of the granting unit 311 is provided so that only one CPU device 100 that has made the first request can perform the diagnosis processing for the I/O device 200. Therefore, the management authority may be provided individually for each I/O device 200. That is, the authority illustrated in FIG. 12 may be provided individually for each I/O device 200.

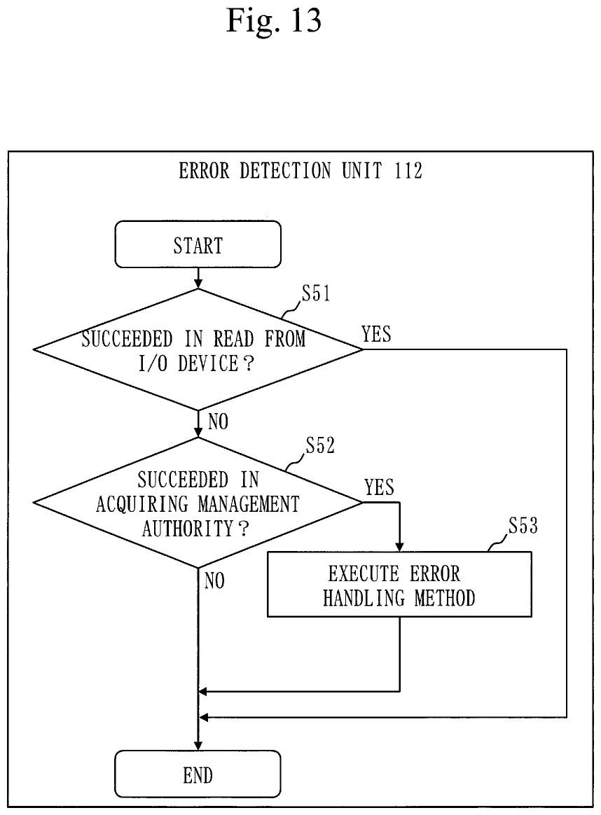

FIG. 13 is a flowchart of the error detection unit 112 of the CPU device 100. When a read from the I/O device 200 fails, the error detection unit 112 of the CPU device 100 makes a request for the management authority for the I/O device 200 in which an error has occurred to the granting unit 311 of the authority device 300. This will be described specifically below.

In step S51, the error detection unit 112 determines whether the read unit 111 has succeeded in a read from the I/O device 200. If it has succeeded, processing ends. If the read unit 111 has failed in the read from the peripheral device, processing proceeds to S52.

In step S52, the error detection unit 112 of the CPU device 100 attempts to acquire the management authority for the I/O device 200 from the authority device 300. Specifically, the error detection unit 112 makes a request for being granted the management authority to the granting unit 311. If the management authority is granted to the error detection unit 112 from the granting unit 311, processing proceeds to S53. If the management authority is not granted to the error detection unit 112 from the granting unit 311, processing ends.

In step S53, based on the acquired management authority, the error detection unit 112 executes the error handling method for the peripheral device in which the error has occurred. The management authority here corresponds to the first authority.

FIG. 14 illustrates operation of the controller 10 of the fourth embodiment. Referring to FIG. 14, the operation of the controller 10 will be described. Step S61 to step S63 are the same as step S21 to step S23, so that description will be omitted. In step S64, in the CPU device #2 the error detection unit 112 detects the failure in the read by the read unit 111. The error detection unit 112 makes a request for acquisition of the management authority to the granting unit 311 of the authority device 300.

In step S65, since the initial state of the granting unit 311 is the management enabled state, the error detection unit 112 of the CPU device #2 acquires the management authority from the granting unit 311.

In step S66, the error detection unit 112 of the CPU device #2, which has acquired the management authority, executes the error handling method for the I/O device #1.

The CPU device #3 is also executing the control program 121 in parallel. In step S67, therefore, the read unit 111 of the CPU device #3 attempts a read from the I/O device #1 while the error handling method for the I/O device #1 of step S66 is being executed by the CPU device #2. The read by the CPU device #3 fails.

In step S68, in the CPU device #3 the error detection unit 112 detects the failure in the read by the read unit 111, and makes a request for acquisition of the management authority to the granting unit 311. However, the granting unit 311 is in the management disabled state, so that the error detection unit 112 of the CPU device #3 fails to acquire the management authority and does not execute the error handling method for the I/O device #1.

### Effects of Fourth Embodiment

In the fourth embodiment, all the CPU devices have the error handling methods for all the peripheral devices. That is, all the CPU devices can be the management device of any one of the first to third embodiments for any peripheral device. In the fourth embodiment, the error notification 601 used in the first to third embodiments is not required. In addition, more than one CPU device will not simultaneously become the management device for one peripheral device. Therefore, according to the fourth embodiment, it is possible to promptly handle an error in the peripheral device 200, and eliminate redundant error handling for the same peripheral device by more than one CPU device.

<Supplement to the Hardware Configurations>

The hardware configurations of the CPU device 100, the I/O device 200, and the authority device 300 will be described supplementarily. In the CPU device #1 of FIG. 2, the I/O device 200 of FIG. 3, the I/O device 200 of FIG. 7, and the authority device 300 of FIG. 11, the functions of each device are realized by software, but the functions of each device may be realized by hardware.

In the following, the CPU device 100 will be described as an example. In FIG. 2, the functions of the read unit 111, the error detection unit 112, and the communication unit 113 are realized by the program. However, the functions of the read unit 111, the error detection unit 112, and the communication unit 113 may be realized by hardware.

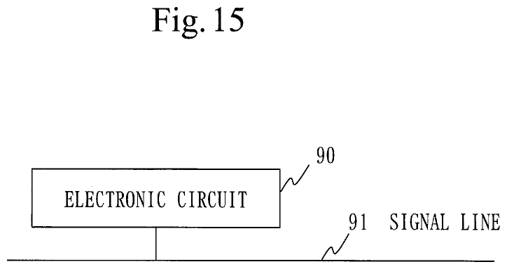

FIG. 15 illustrates a configuration in which the read unit 111, the error detection unit 112, and the communication unit 113 are realized by hardware. An electronic circuit 90 of FIG. 15 is a dedicated electronic circuit that realizes the functions of the read unit 111, the error detection unit 112, the communication unit 113, the main storage device 120, the auxiliary storage device 130, and the communication interface device 140. The electronic circuit 90 is connected to a signal line 91.

Specifically, the electronic circuit 90 is a single circuit, a composite circuit, a programmed-processor, a parallel-programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array. The functions of the constituent elements of the CPU device 100 may be realized by one electronic circuit, or may be distributed among and realized by a plurality of electronic circuits. Some of the functions of the constituent elements of the CPU device 100 may be realized by the electronic circuit, and the rest of the functions may be realized by software.

Each of the processor 110 and the electronic circuit 90 is also called processing circuitry. In the CPU device 100, the functions of the read unit 111, the error detection unit 112, the communication unit 113, the main storage device 120, the auxiliary storage device 130, and the communication interface device 140 may be realized by the processing circuitry.

The control program 121 that realizes the functions of the read unit 111, the error detection unit 112, and the communication unit 113 may be stored and provided in a computer readable recording medium, or may be provided as a program product.

The supplement to the hardware of the CPU device 100 described above also applies to the I/O device 200 and the authority device 300. That is, the program 201 that realizes the functions of the I/O device 200 and the program 301 that realizes the functions of the authority device 300 may each be stored and provided in a computer readable recording medium, or may be provided as a program product. The functions of the I/O device 200 and the functions of the authority device 300 may be realized by the processing circuitry.

The procedure for the operation of the CPU device 100 described above corresponds to a processing method. The program that realizes the operation of the CPU device 100 corresponds to the control program 121. The procedure for the operation of the I/O device 200 corresponds to a method performed by the I/O device 200. The program that realizes the operation of the I/O device 200 corresponds to the program 201. The procedure for the operation of the authority device 300 corresponds to a method performed by the authority device 300. The program that realizes the operation of the authority device 300 corresponds to the program 301.

The embodiments are examples of preferable embodiments and are not intended to limit the technical scope of the present invention. The embodiments may be partially implemented, or may be implemented in combination with another embodiment. The procedures described using the flowcharts may be changed as appropriate.

### REFERENCE SIGNS LIST

10: controller; 100: CPU device; 110: processor; 111: read unit; 112: error detection unit; 113: communication unit; 120: main storage device; 121: control program; 122: error processing information; 130: auxiliary storage device; 140: communication interface device; 200: peripheral device; 201: program; 210: processor; 211: response unit; 212: multi-address transmission unit; 220: main storage device; 230: auxiliary storage device; 240: communication interface device; 250: external input/output device; 300: authority device; 301: program; 310: processor; 311: granting unit; 312: communication unit; 320: main storage device; 330: auxiliary storage device; 340: communication interface device; 351, 352, 353: transition; 400: bus; 601: error notification; 602: management notification; 711, 712, 713, 714, 715, 716, 721, 722, 723, 724, 725, 731, 732, 733, 734, 735, 736, 737, 738, 739, 741, 742, 743, 744, 745, 746: box.

1. A controller comprising:
a plurality of central-processing-unit devices; and
a peripheral device from which data is read by the plurality of central-processing-unit devices,
wherein the plurality of central-processing-unit devices include
a management device and a general device, the management device being a central-processing-unit device that has a first authority to manage the peripheral device, the general device being a central-processing-unit device that has a second authority, which is lower than the first authority, to diagnose an error in the peripheral device in which the error has occurred,
wherein the general device reads data from the peripheral device, and executes a diagnosis on the peripheral device based on the second authority when a data read from the peripheral device has failed, and
wherein the management device is caused, by the diagnosis, to receive an error notification indicating the error in the peripheral device, and handles the error in the peripheral device based on the first authority when the error notification is received.

2. The controller according to claim 1,
wherein the general device reads an error code from the peripheral device as execution of the diagnosis, and upon reading the error code, transmits the error notification to the management device.

3. The controller according to claim 1,
wherein the peripheral device transmits the error notification to the plurality of central-processing-unit devices by multi-address transmission when the diagnosis has been executed by the general device.

4. The controller according to claim 2,
wherein the management device receives the error notification from each of a plurality of general devices, and handles the error in the peripheral device based on received error notifications.

5. A controller comprising:
a plurality of central-processing-unit devices; and
an authority device to receive request information requesting granting of an authority to manage a peripheral device from one of the plurality of central-processing-unit devices that has failed in a data read from the peripheral device from which data is to be read by each central-processing-unit device of the plurality of central-processing-unit devices, and when the request information is received, grant the authority to the one of the plurality of central-processing-unit devices that has requested the granting of the authority so as to permit, based on the authority, handling of the peripheral device by the one of the plurality of central-processing-unit devices only when the authority has not been granted to another one of the plurality of central-processing-unit devices.

6. The controller according to claim 2,
wherein the peripheral device transmits the error notification to the plurality of central-processing-unit devices by multi-address transmission when the diagnosis has been executed by the general device.
